(19) United States
(12) Patent Application Publication
(10) Pub. No.: US 2003/0032433 A1
(43) Pub. Date: Feb. 13, 2003

(54) Resource management in cellular networks

(76) Inventors: Yoaz Daniel, Haifa (IL); Moshe Langer, Petah Tiqwa (IL); Aharon Satt, Haifa (IL)

Correspondence Address: MERCHANT & GOULD PC, P.O. BOX 2903, MINNEAPOLIS, MN, 55402-0903, US

(21) Appl. No.: 09/916,190

(22) Filed: Jul. 26, 2001

(51) Int. Cl. H04Q 7/20

(52) U.S. Cl. 455/452; 455/453

(57) ABSTRACT

There are disclosed systems and methods for dynamically managing resources, such as bandwidth and delay in networks, such as cellular networks. These systems and methods dynamically and automatically adjust the bandwidth and delay in individual shared access media or cells “on the fly”, to optimize user experience, usage and packet transmissions in the network.

### TECHNICAL FIELD

The present invention is directed to resource management in cellular networks, and in particular to bandwidth allocation in cellular networks.

### BACKGROUND

Cellular networks, including fixed wireless data networks, mobile networks and networks comprised of many connected wireless local area networks, for example, are currently widely and extensively used. Presently, the number of shared access media or cells, to which a single subscriber may be connected at any given time, is limited by the topology of the cellular network. Each shared access media has limited capability and resources, with exemplary resources including bandwidth, that is for example, implemented as wireless radio transmissions. Presently, available bandwidth for such transmissions is limited technically, by physics, and legally, by regulations.

Because bandwidth is a limited resource in shared access media or cells, it is likely that not all data packets forming a transmission over the band, that are intended for a subscriber, will actually reach that subscriber. Moreover, packet traffic is “bursty” by its general nature-with periods of high bandwidth demand and periods of lower demand. This results in service that cannot be guaranteed, and therefore, there is a need to monitor and control the levels of service for subscribers of shared access media or cells.

Currently, bandwidth allocation is controlled by applying traffic shapers. Traffic shapers are apparatus, typically routers or switches, that are typically positioned between servers and shared access media or cells. They are capable of categorizing data packets into various service classes and allocating the service classes different bandwidth sectors or portions. They typically perform this allocation by queuing methods, where the various queues correspond to the various service classes. There are numerous drawbacks with current traffic shapers, and some major drawbacks are now detailed.

These conventional traffic shapers, typically operate in real time and allocate or budget bandwidth according to a fixed or static settings. This is problematic because when optimizing or changing the allocations or budgets is desired, the traffic shapers must be reconfigured manually. This is labor intensive and simply can not accommodate the constantly changing bandwidth. As a result, these contemporary traffic shapers can not match allocations to both changing cell resources and service, resulting in deterioration or loss of service in the requisite shared access media or cell, due to this failure to match.

These conventional traffic shapers are not scaleable. For example, a network may include thousands of shared access media or cells, within a network serving millions of subscribers. The contemporary systems are simply limited, because they are manually operable and manually configured, manually in the sense that determining the bandwidth allocation is done manually. Since the allocation for each cell should be determined separately, scalability is not possible.

Additionally, these traffic shapers are not capable of accommodating user experience within their allocation methods or processes. For example, a user experience may be related to parameters such as unavailability of service, number of interruptions during a service, numbers of service drop-offs leading to failures, etc. These parameters can not be controlled by these traffic shapers, but rather, they can only be measured.

### SUMMARY

The present invention improves on the contemporary art by providing systems and methods for dynamically managing resources, such as bandwidth and delay. In doing so, there is provided a method for dynamically and automatically adjusting the bandwidth and delay in individual shared access media or cells “on the fly”, to optimize user experience, usage and packet transmissions in the network. In dynamically managing resources, parameters closer to those associated with user experiences are employed. The invention is scalable, and can accommodate large networks with large numbers, for example, with thousands of shared access media or cells. Embodiments of the invention are directed to monitoring and controlling service levels (also referred to as level or levels of service) in individual shared access media or cells.

An embodiment of the present invention is directed to a method for allocating resources in a cellular network comprising, monitoring the cellular network, this monitoring comprising, continuously measuring approximate available bandwidth within at least one shared media (or cell) in the cellular network, and continuously measuring the demand for bandwidth within the at least one shared media, for at least two service classes. Bandwidth allocations are automatically changed for each of the at least two service classes in accordance with at least one value from the continuously measured approximate available bandwidth and at least one value from the continuously measured demand for bandwidth. Bandwidth allocations are typically in the form of sectors and their corresponding supplements, with changes to the sectors and supplements being either by, setting (or resetting) the sectors and their corresponding supplements, or tuning the sectors and their corresponding supplements.

Another embodiment of the invention is directed to an apparatus for allocating resources in at least one cellular network. This apparatus includes a storage medium and a processor, e.g., a microprocessor. The processor is programmed to, monitor the cellular network, including continuously measuring approximate available bandwidth within at least one shared media (or cell) in the cellular network, and continuously measuring the demand for bandwidth within the at least one shared media, for at least two service classes. The processor is also programmed to automatically change bandwidth allocations for each of the at least two service classes in accordance with at least one value from the continuously measured approximate available bandwidth and at least one value from the continuously measured demand for bandwidth.

Another embodiment of the invention is directed to a programmable storage device readable by a machine, tangibly embodying a program of instructions executable by a machine to perform method steps for providing resource allocations in a cellular network, the method steps selectively executed during the time when the program of instructions is executed on the machine, comprising, monitoring said cellular network. This monitoring includes, continuously measuring approximate available bandwidth within at least one shared media in said cellular network, continuously measuring the demand for bandwidth within said at least one shared media (or cell), for at least two service classes. The method steps also include automatically changing bandwidth allocations for each of the at least two service classes in accordance with at least one value from the continuously measured approximate available bandwidth and at least one value from the continuously measured demand for bandwidth.

### BRIEF DESCRIPTION OF THE DRAWINGS

Attention is now directed to the attached drawings, wherein like reference numerals or characters indicate corresponding or like components. In the drawings:

FIG. 1 is a diagram of an exemplary system employing an embodiment of the present invention;

FIG. 2 is a flow diagram of a process in accordance with an embodiment of the present invention;

FIG. 3 is a diagram of an exemplary system employing a second embodiment of the present invention;

FIG. 4 is a diagram of an exemplary system employing a third embodiment of the present invention;

FIG. 5 is a diagram of an exemplary system employing a fourth embodiment of the present invention; and

FIG. 6 is a diagram of an exemplary system employing a fifth embodiment of the present invention.

### DETAILED DESCRIPTION OF THE DRAWINGS

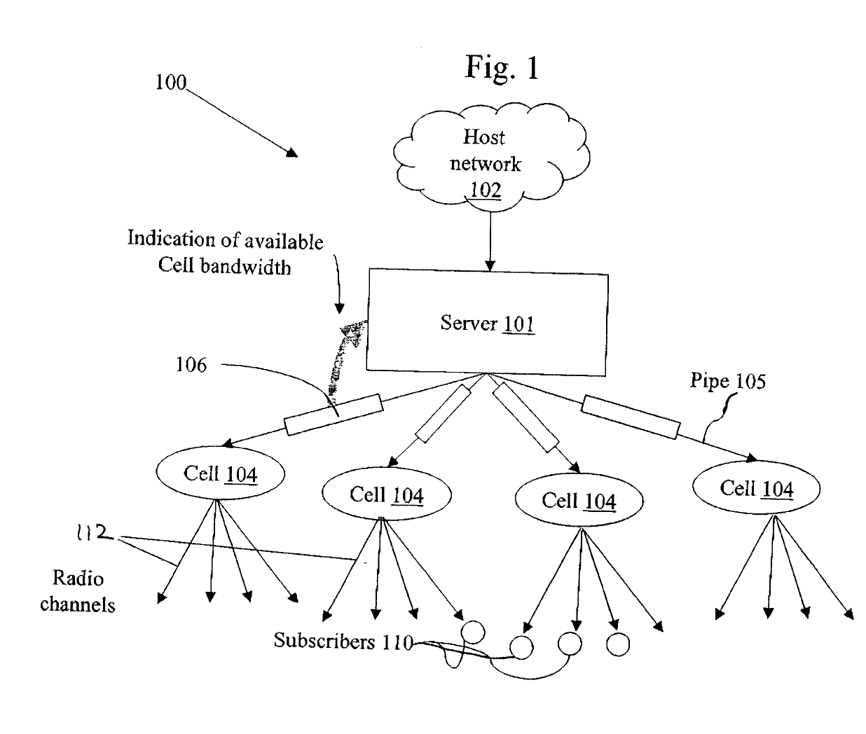

FIG. 1 shows an exemplary system 100, including a server 101, manager, gateway or the like, that performs the invention, typically in software, hardware or combinations thereof. The server 101 typically includes components such as storage media, processors (including microprocessors), queuing systems, and other hardware and software components, and is in communication with a host network 102, such as the Internet, Local Area Network (LAN), Wide Area Network (WAN), etc., and wireless network (that includes cells), or the like. The server 101 communicates with shared access media or cells 104, over pipes (communication channels or the like) 105. Queuing devices 106, sit within the network and may, for example, sit along the pipes 105, but can also sit within the cells 104, or any other point where the traffic to the cell 104 flows through it. Subscribers 110 are provided services from one or more shared access media or cells 104, typically over air interfaces through radio channels 112.

The present invention allocates resources, such as for example, bandwidth and delay, in shared access media or cells in accordance with the various service classes at each shared access media or cell. There are typically multiple, e.g., 20-30 service classes, each class typically in one of the following four categories, these categories including: a) Delay Sensitive Interactive; b) Streaming; c) Delay Sensitive Small File Download: and d) Average Bit Rate Download. The actual number of service classes, and their categorizations, is typically defined by the administrator.

The Delay Sensitive Interactive service category may include for example, interactive mobile commerce (M-commerce). Its characteristics include small frequent bursts of a few packets each. The Quality Of Service (QOS) major parameters typically involve a delay for each packet. The demand is related to the amount of packets required to be transferred subject to a certain delay. The typical minimum or guaranteed bandwidth for this service category is, for example, approximately 8 kilo bits per second (kbps), for a group of 100 subscribers.

The Streaming service category may include for example, streaming video. Its characteristics include substantially constant bit rate packet flows. The QOS parameters typically involve bit rate, delay and jitter. The demand is related to the number of individual flows and the bit rate per flow. The typical minimum or guaranteed bandwidth for this service category is, for example, approximately 8 kbps per flow. Where a flow may be defined, for example, as a stream of packets delivering a single application (e.g. video) to a single subscriber from a single source (host).

The Delay Sensitive Small File Transfer service category may include for example, picture downloading or the like. Its characteristics include relatively small flows of packets. For instance, the download size may be typically 2 kilo bytes. The QOS major parameters typically involve the time required to transfer an entire packet flow. The demand is related to the number of flows (for example, one flow may equal one picture to be transferred) subject to certain transferring time and certain flow sizes. The typical minimum or guaranteed bandwidth for this service category is, for example, approximately 4 kbps, to support traffic (aggregation of packets) created by a few users, for example, ten users.

The Average Bit Rate Download service category may include for example, a large file download, using file transfer protocol (FTP) to a laptop computer or other computer or workstation connected over the air within a cell, or the like. Its characteristics include relatively large flows of packets. The QOS major parameter typically involves average bit rate (in kbps). The demand is related to the average bit rate per flow. The typical minimum or guaranteed bandwidth for this service category is, for example, approximately 5-8 kbps per user averaged over long periods (five or more minutes).

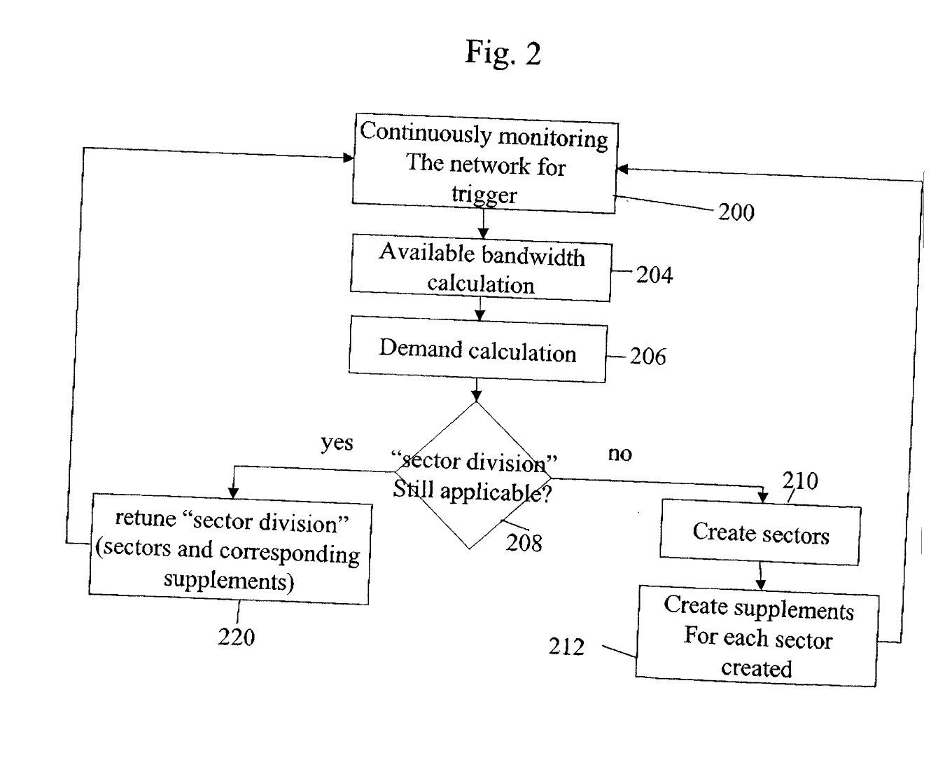

Turning also to FIG. 2, there is detailed a process in accordance with an embodiment of the present invention. While a single cycle is shown, this process can also be performed in multiple cycles.

This process is an iterative process over time. The process originates from a triggering event, and utilizes measurements, taken from monitoring the available bandwidth, typically by continuously monitoring the network, in at least one shared access media, typically a cell, of a cellular network. In addition, the demand per service class is measured and calculated, also by monitoring, and typically continuously, monitoring, the network.

These measurements are then used in resource allocation. Resource allocation typically involves changing the resource. This resource is typically bandwidth, that is allocated into sectors and supplemental portions or supplements. Sectors are formed from allocations of guaranteed bandwidth, for each service class. Supplemental portions or supplements, to the corresponding sectors, are formed from allocations of non-guaranteed bandwidth. The bandwidth in these supplemental portions or supplements is in addition to the bandwidth of the corresponding sector.

This changing the resource typically involves either: 1. setting (resetting) the bandwidth allocations for both the sectors and the supplemental portions or supplements; or 2. tuning the existing sectors and their corresponding supplemental portions. When setting or tuning the sectors and supplements, either or both of the sector and the supplement can be set to zero, so as to be nonexistent for each service class. Each supplemental portion (supplement) is non-guaranteed, allowing the corresponding service class to borrow bandwidth, up to the amount of the supplemental portion.

This process can be repeated upon receiving a subsequent trigger (triggering event).

This process typically accommodates multiple cells, one cell at a time, assuming independent calculations for each cell. This process is repeated for each cell connected to the server 101. This process described for example, in accordance with the downlink traffic, in the direction from the host network 102 to the subscribers 110 (as per FIG. 1). However, it can be modified slightly, as detailed below, to accommodate uplink traffic.

Prior to this process beginning, the system administrator identifies all service classes, places each one of them into one of the service categories, such as one of the four service categories detailed above, and assigns each service class a priority, as well as a target “blocking rate” (detailed below) and a target “killing rate” (detailed below).

The process begins at block 200, where the process is initiated, typically by a triggering event (also referred to as a trigger), for example, a periodic clock, or an event that is dependent on a measurement threshold. This threshold can be preset by a system administrator. For example, the process may trigger once every ten milliseconds, or following a traffic threshold of 100 Kilobytes. By having a triggering event, the system 100 (FIG. 1) continuously monitors the network, the available resources, such as bandwidth and the demand for resources, such as bandwidth.

Once triggered, the available cell bandwidth is calculated, at block 204. This calculation is typically contemporaneous with the calculation of the bandwidth demand at block 206.

Returning to block 204, available cell bandwidth can be calculated, for example, by monitoring the system 100 at the queuing device 106. Specifically, the queuing device 106 has a “bucket” whose size and leak rate can be measured. The cell bandwidth is approximately equal to the average leak rate (when leaks are evaluated at a minimum of one timed interval) under the condition that bucket size has built up to a certain threshold. This threshold occurs when there is a continuous flow of packets leaking from the bucket. Since the aforementioned calculation is an approximation, the available bandwidth is typically considered to be a fractional part of this calculation, for example 90%.

The calculation of the bandwidth demand at block 206 is based on a demand in flows (D_{F}) and demand in bytes (D_{B}), subject to weighting factors. These weighting factors are typically dependent on specific service categories.

For example, video phone calls, where bit rate is constant, per call demand, may have a demand in terms of flows (calls). This is similar to ordinary telephone calls.

On the other hand, for example, with file transfers, it is important to account for numbers of bytes transferred per flow, in addition to the numbers of flows. In this case, demand would be in terms of flows and bytes, with the weighting factor between demand in flows and demand in bytes dependent on specific classes of service.

Weighting factors (W_{F}—for flows, W_{B}—for bytes) can be W_{F}=1.0 and W_{B}=0.0, for video streams with constant bit rate; and W_{F}=0.5 =W_{B} for file downloads. In the latter example (file transfers), the weighting factor takes into account the numbers of users (via D_{F}) and file sizes (via D_{B}).

The bandwidth demand, at block 206, is calculated according to the following formulas with three calculations.

First, the demand per service class, in terms of bytes (D_{B}), is calculated. This is done by averaging the bytes per second (or other time unit) as the requisite traffic passes through the server 101 (FIG. 1) or other traffic measuring device. The averaging function can be, for example, a sliding window average, an exponential window, or any other averaging function that is calculated over time. An exemplary averaging function is expressed as follows:

$${D}_{B , i} = \frac{Avg ( {D}_{M , i} , {D}_{S , i} )}{C} \qquad ( 1 )$$

where,

D_{B,l} is the demand in bytes at time “t” for service class i;

D_{S,l} a state (memory) at time “t” for service class i;

D_{M,i} is the measurements of bytes per second at time “t” for service class i, as measured at the server 101 (FIG. 1) or other traffic measuring device;

C is the available cell bandwidth calculated at block 204;

n is the number of service classes in the cell; and

Avg is an averaging function, this can be arithmetic, geometric, etc., for example, an arithmetic average according to the following formula:

$$Avg ( {D}_{M , i}^{F} , {D}_{M , i}^{S} ) = \frac{1}{2} ( {D}_{M , i}^{F} + {D}_{M , i}^{S} ) \qquad ( 2 )$$

Second, a demand in terms of flows, or “flow demand” (D_{F}), is calculated. Assuming a uniform distribution of flows per users within a service class, the flow demand is approximately proportional to the demand in terms of users, that is the number of distinct users wishing to obtain the specific service. An exemplary averaging formula is expressed as follows:

$${D}_{F , i} = \frac{Avg ( {D}_{S , i}^{F} , {D}_{M , i}^{F} ) \cdot {B}_{i}}{C} , i = 1 , 2 , … n \qquad ( 3 )$$

where,

D_{F,l} is the flow demand at time “t” for service class i;

D_{S,i}^{F} is state (memory) at time “t” for service class i;

Bₗ is a constant defining the expected value of byte per second per flow for service class i (this constant is typically defined by the administrator, for example, 20 Kbps for a certain video service);

D_{M,l}^{F} is the measurement of the number of incoming flows from the host network 102 (FIG. 1) through the server 101 (FIG. 1) as measured at the server 101 (FIG. 1) or other traffic measuring device, for service class i;

i is the number identifying a specific service class, from 1 to n; and

Avg is an averaging function. This can be arithmetic, geometric, etc. the default being simple arithmetic according to the following formula:

$$Avg ( {D}_{M , i}^{F} , {D}_{M , i}^{S} ) = \frac{1}{2} ( {D}_{M , i}^{F} + {D}_{M , i}^{S} ) \qquad ( 4 )$$

Third, the “total demand”, “universal demand”, “demand for bandwidth” or “demand” is calculated for the requisite service class, based on the results of the first D_{B} and second D_{F} calculations above. In the above two calculations, both byte demand D_{B} and flow demand D_{F} are absolute unit-less values, and are thus comparable. An exemplary calculation is according to the following formula:

δᵢ=Avg(D_{F,l}, D_{B,l})·C (5)

where,

δₗ is the calculated demand for service class i; and

Avg is an averaging function, that can be an arithmetic average, geometric average, harmonic average, etc. An example of averages is the weighted arithmetic average, as expressed in the following formula:

δₗ=(W_{F,l}D_{F,l}+W_{B,l}D_{B,l})·C (6)

where,

W_{F,i} and W_{B,i} are weighting factors for service class i, of the requisite shared media or cell—they are typically set by the administrator, or as detailed above.

In Equations (5) and (6), multiplication by “C” (available bandwidth for the requisite shared media or cell) ensures that the demand is given in terms of bandwidth or bit rate, typically in kbps.

The above detailed three calculations are repeated for each requisite service class, resulting in a unique universal demand value, or demand, for each service class, within the requisite cell.

It is then determined if the previous division into sectors and supplements, known hereinafter as a “sector division”, if it exists, is still applicable, at block 208. A sector division is applicable (sufficient), only if the sectors and supplements need to be tuned, and not set (reset) into new sectors and supplements, these new sectors and supplements not being based on the previous sector division. For example, if the average demand across all service classes has increased or decreased by more than 50% relative to the previous cycle, or other administrator-set threshold or combination of thresholds (relating is to demand, available cell bandwidth, system stability, performance issues, etc.) has been attained, then the previous sector division is no longer applicable. Accordingly, this previous sector division must be changed by setting (resetting) the sectors and supplemental portions or supplements, as per blocks 210 and 212. Otherwise, the sector division is changed by tuning, whereby the process moves to block 220.

If a previous sector division is no longer applicable, then the calculations at blocks 204 and 206 are then utilized to divide the available bandwidth, first into sectors of guaranteed bandwidth, in accordance with the service classes, at block 210. Each of the sectors for the requisite service class is further allocated a supplement of a non-guaranteed portion of bandwidth, at block 212. This supplement is in addition to the corresponding sector of guaranteed bandwidth.

To establish these sectors and supplements at blocks 210 and 212, two concepts are initially introduced. These concepts include “blocking rates” and “killing rates”.

Blocking and killing rates arise based on the assumption that in creating sectors (at block 210), the overall demand, which is the sum of all demands for all service classes, is greater than the available cell bandwidth. Hence, individual demands per service class will not always be satisfied. To optimize bandwidth allocation, an optimization process in terms of killing and blocking rates, can be introduced, that includes user experience based criteria.

The “blocking rate” for a certain service class may be defined as the relative difference between demanded bandwidth, as calculated in Equation (5) above for the certain service class, and the actual bandwidth allocated to that certain service class. This blocking rate describes the relative amount of unsatisfied demand for service in the certain service class. In comparison to telephony voice service, it is a generalization of the probability of service blocking or “busy tone”.

The “killing rate” for a certain service class is a measure of the relative rate in which existing flows are killed or terminated while going (involuntarily terminated). Flows are involuntarily terminated (killed), typically in order to keep bandwidth per existing (going) flow constant while shrinking existing resource allocation. Killing any existing flow or flows is optional, as per policies of the system administrator, per service class. The “killing rate” is the number of flows killed divided by the overall number of admitted flows over a predetermined time period.

Prior to system operation, the administrator will set a target blocking rate for each service class and a target killing rate for each service class. The target blocking rate and target killing rate are thresholds for an acceptable service level for each service class, in terms of user experience. Since in most cases, target blocking rates and target killing rates are exceeded, due to high demand, the administrator has to set priorities for each individual service class, typically to minimize interruptions, delays, blockages, etc., with important service classes.

Creating sectors is preformed at block 210. This is a process, whereby allocation of bandwidth for each sector “S” (in kbps) is done iteratively based on the demand calculated above, at block 206.

For example, first, each sector is created by an allocation proportional to the demand calculated for its requisite service class, following the assumption that enlarging the resources allocated to a service class would reduce its expected blocking rate. Where the exact proportions for each service class Sᵢ might be, for example, in accordance with the formula:

$${S}_{i} = \frac{{δ}_{i}}{{\sum }_{j = 1}^{n} {δ}_{j}} \cdot C \qquad ( 7 )$$

Next, an iterative correction process may be applied, in order to take into account the administrator's pre-determined priorities for service classes. A fixed number of iterations take place, the default being two iterations. In the first iteration the highest priority service class is taken, in the second, the second highest priority service class is chosen, etc. At each iteration, it is first tested whether the sector allocated for the service is larger or smaller than its demand.

If the sector is larger than the demand, the demand is satisfied, and changes in allocation are not necessary. If the sector is smaller than the demand, the relevant sector, for example, designated i₀, is enlarged, by adding bandwidth in accordance with the following formula:

$${S}_{{i}_{0}} = \frac{{S}_{{i}_{0}} + min ( {C}^{0} , {δ}_{{i}_{0}} )}{2} \qquad ( 8 )$$

where,

C⁰ is the amount of available resources at the first iteration. It is typically equal to the cell bandwidth.

Next, each of the other sectors is reduced in bandwidth proportionally, in accordance with the following formula:

$${S}_{j} = \frac{{S}_{j}}{{\sum }_{k \neq {i}_{i}} {S}_{k}} \cdot ( {C}^{0} - {S}_{{i}_{0}} ) , j = 1 , 2 , … , n , j \neq {i}_{0} \qquad ( 9 )$$

In the second iteration, the computations of Equations (8) and (9) are repeated, with the amount of available resources C⁰ in Equation (8) is replaced by an amount C¹ which is an average of C⁰ minus the enlarged allocation, Sₗ_{₀} , and C⁰. For example, this average could be a simple arithmetic average as in the following formula:

$${C}^{1} = \frac{( {C}^{0} - {S}_{{i}_{0}} ) + {C}^{0}}{2} . \qquad ( 10 )$$

In addition, in the second iteration the sector to be dealt with, i₀ is changed to sector i₁ which corresponds, to the second-highest priority service class.

In another example, all sectors can be set equally, whereby the sum of all sectors is equal to the available cell bandwidth, and the supplemental portions (supplements) can be set to zero for all service classes.

In another example, all sectors can be set to zero and all supplemental portions (supplements) can be set to be equal to the available cell bandwidth, for all the service classes.

The process continues at block 212, as the supplemental portions or supplements are created for each sector previously created in block 210.

The supplemental portions or supplements are created to allow for the lending and borrowing of bandwidth by the various sectors, using a lending and borrowing mechanism(s). This lending and borrowing mechanism(s) involves determining the “spare” bandwidth, and allocating it accordingly. This “spare” bandwidth includes the sum of: 1. bandwidth not allocated to the sectors, and 2. bandwidth allocated to the sectors and not utilized.

In a typical operation, the lending and borrowing mechanism is used to satisfy the demanded traffic bandwidth in each service class, up to at least its guaranteed allocation of bandwidth (sector). If more demanded traffic bandwidth exists, it is desired to satisfy it, up to the limit of the bandwidth in the non-guaranteed supplemental portion (supplement), based on the “spare” bandwidth. The allocation of spare bandwidth to the supplements (of their respective sectors) depends on predetermined priorities, as set by the administrator, per service class.

If a service class has not reached the bandwidth guaranteed to it, then, other service classes may “borrow” bandwidth from it, typically based on the administrator-set priorities. However, whenever there new traffic, resulting in a demand for bandwidth by the requisite service class, this previously borrowed bandwidth must be returned to this service class.

In an exemplary operation, the resource allocation supporting the lending and borrowing mechanism can be implemented as follows.

A supplement of non-guaranteed bandwidth is added to each service class (sector), enabling it to borrow bandwidth from other service classes (sectors). In what follows, we refer to the sum of the sector and its supplement for a service class i, as the “total allocation” of service class i. The total allocation is determined according to the following formula:

Tₗ=Sₗ·Rᵢ (11)

where,

Tₗ is the total allocation for service class i; and

Rₗ is the normalization factor of service class i.

An exemplary normalization factor, Rᵢ, can be chosen to take into account the administrators pre-determined blocking rate target and killing rate target for each service class, as in, for example, the following formula:

$${R}_{i} = \frac{1 + {k}_{i}}{1 - {b}_{i}} \qquad ( 12 )$$

where,

kₗ is the administrators pre-determined target killing rate, and is in the range of 0 to 1, the default being 0.1; and

bₗ is the administrators pre-determined target blocking rate, in the range 0 to 0.99, the default being 0.1.

With sectors and their respective supplements now created, the process returns to block 200.

At block 220, tuning, typically by modifications and adjustments, to the sector division (sectors and their respective supplements) is now made. This tuning is based on actually measured killing and blocking rates, and takes place iteratively in one or more cycles over time. This process is dynamic, typically preformed on the fly, and resulting from monitoring the network, typically continuously.

An exemplary implementation for the process of block 220 is detailed below. Initially, actual measured killing rates and blocking rates for each service class are compared to their respective target rates. If the actual measured values, are greater than their respective target rates, then the respective sectors and their respective supplements are adjusted, to move the next measured blocking and killing rates downward, toward their respective target rates.

In an exemplary operation, adjustments are made by an iterative process, typically in two iterations. Prior to the first iteration, one service class with the greatest distance between the actual measured killing rate and target killing rate is selected. Similarly, one service class with the greatest distance between the actual measured blocking rate and target blocking rate is selected.

This selection process begins, with calculations of the following distance functions for all of the service classes (both blocking rates and killing rates), as per the following equations:

Ψᵢ^{B}=pₗ·δₗ·min(β_{count}^{l}−βₗ) (13)

Ψᵢ^{K}=pᵢ·δᵢ·min(k_{count}^{l}−kₗ) (14)

wherein,

Ψₗ^{B} is the calculated distance of blocking rate from the target blocking rate for service class i;

Ψₗ^{K} is the calculated distance of killing rate from the target killing rate for service class i;

βₗ is the pre-determined blocking rate target of service class i;

kᵢ is the pre-determined killing rate target of service class i;

pₗ is the priority of the service class i, as pre-defined by the system's administrator. It is a number in the range from 0 to 1;

δₗ is the demand for service class i as calculated in block 204;

β_{count}^{l} is the measured blocking rate of service class i, measured typically at server 101 (FIG. 1); and

k_{count}^{l} is the measured killing rate of service class i measured typically at server 101 (FIG. 1).

The service class with the greatest distance in terms of killing rate, also known as the “worst case” service class, Ψₗ^{K}, is selected. For example, this service class is designated i₀. If this distance is zero or less than zero, adjustments are not made.

If this distance is positive, than the sector of service class i₀ is enlarged and its respective supplement is reduced. This is done, for example, according to the formulas:

$$\begin{matrix}{S}_{N} = {S}_{O} \cdot ( \frac{{β}_{count}}{β + {β}_{count}} ) + {T}_{O} \cdot ( \frac{β}{β + {β}_{count}} ) , and & ( 15 ) \\ {T}_{N} = {S}_{O} \cdot ( \frac{β}{β + {β}_{count}} ) + {T}_{O} \cdot ( \frac{{β}_{count}}{β + {β}_{count}} ) & ( 16 )\end{matrix}$$

where,

S_{N} is the newly calculated sector for the service class i₀;

S_{O} is the previous sector for the service class i₀;

T_{N} is the newly calculated total allocation for the service class i₀; and

T_{O} is the previous total allocation for the service class i₀.

With respect to the blocking rate, the first iteration continues by identifying the largest blocking rate distance; that is, the service class with the greatest distance between actual and target rate, Ψₗ^{B}, is selected. This service class is for example designated i₀ If this distance is zero or less, adjustments are not made. If this distance is positive, the sector and its respective supplement for this service class are enlarged, by enlarging its total allocation according to the following formula:

$${T}_{N} = ( 1 + log ( \frac{{β}_{count}}{β} ) ) \cdot {T}_{O} \qquad ( 17 )$$

where,

T_{N} is the newly calculated total allocation for service class i₀; and

T_{O} is the previous total allocation for service class i₀.

The sector for the service class i₀ is typically enlarged proportionally, according to the following formula:

$${G}_{N} = \frac{{T}_{N}}{{T}_{O}} \cdot {G}_{O} \qquad ( 18 )$$

To conclude this single iteration step, all sectors are normalized so that their sum would not exceed the available cell bandwidth, thus avoiding the possibility of guaranteeing more resources than are available. This is done according to the following formula:

$${S}_{i}^{N} = \frac{{S}_{i}^{O}}{{\sum }_{j = 1}^{n} {S}_{j}^{O}} \cdot C , \qquad ( 19 )$$

where,

Sₗ^{N} is the new calculated sector for service class i; and

Sₗ^{O} is the previous sector for service class i.

In Equation (19), if Sₗ^{O} equals zero for all service classes, then Sₗ^{N} is set to zero for all service classes.

The above computations conclude a single iteration step of block 220. Successive iterations may be conducted similarly, where at each step, the blocking and killing distances that are picked are of smaller magnitudes, than previously selected blocking and killing distances. The process then returns to block 200.

In returning to block 200, from block 212 or block 220, a cycle is complete. During this cycle, resource allocation has been performed dynamically in an automatic manner and “on the fly”. Subsequent cycle(s) may be performed as necessary or desired (upon returning to block 200).

In an alternate embodiment a subscriber may receive service, or traffic, through multiple cells simultaneously. The above detailed process would apply, by considering the traffic for the individual subscriber within each cell serving the requisite subscriber independently.

In yet another embodiment, the concept of a “session” is introduced. A session includes a sequence, or sequences, of flows. For example, a session may begin with an interactive transaction, followed by live video stream, followed by another interactive transaction, and concluded by file download. In this case blocking rate, killing rate and demand may refer to sessions as opposed to individual flows.

The invention is also useful in wireless LANs. In this case, each wireless LAN is a shared media or cell, and the multiple wireless LANs connected together form a cellular network, similar to system 100 of FIG. 1.

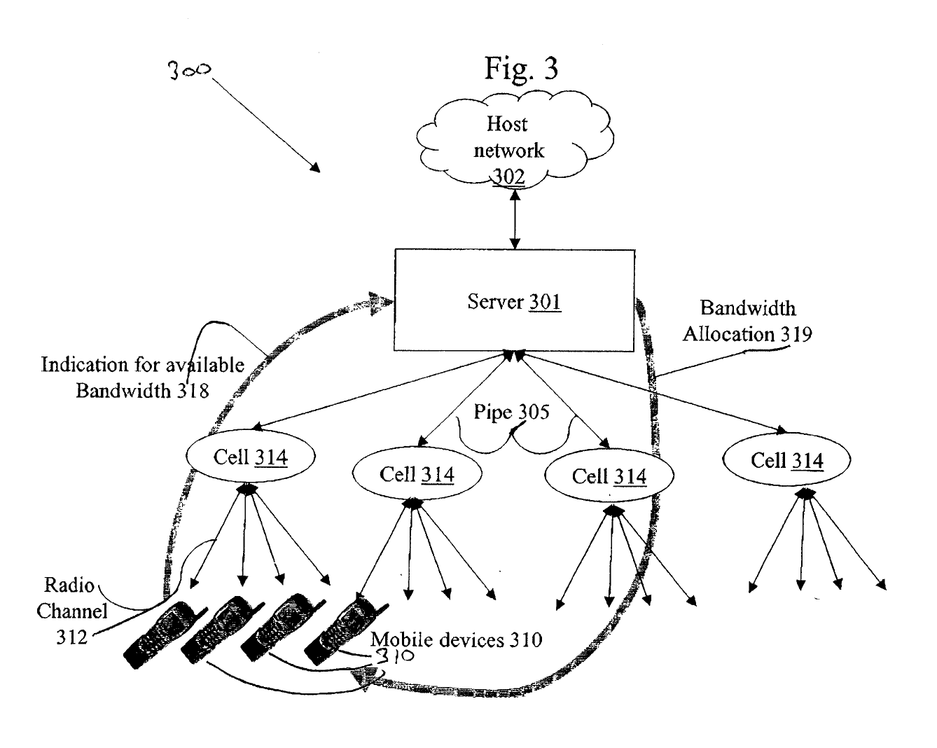

FIG. 3 shows an alternate system 300 as an exemplary system in accordance with the invention. The system 300 includes a server 301, manager, gateway or the like, that performs the invention, in a manner similar to that of server 101. This server 301 is in communication with a host network 302, such as the Internet, LAN, WAN, etc., and with queuing devices (similar to queuing devices 106 as described above, not shown in this figure), and situated at least partially within the mobile devices 310. These mobile devices 310, may be, for example, cellular phones (as shown), laptop computers, or any other device capable of transmission over radio channels 312. The server 301 communicates with mobile devices 310 through cells 314 (the cells 314 in communication with the sever 301 via pipes 315—similar to that described for FIG. 1 above) and radio channels 312, similar to cells 108 and radio channels 109 detailed for FIG. 1 above.

In operation, mobile devices 310 send data traffic to the host network 302 in the “uplink” direction, through the radio channels 312, the cells 314, pipes 315, and server 301. The server 301 retrieves inputs from mobile devices 310, indicating both available bandwidth and demand sizes per mobile device 310. The server 301 deploys control over mobile devices' resources, through bandwidth allocation for mobile devices 310. Here, the cell bandwidth is calculated through aggregation of the available bandwidth measurements over all of the mobile devices 310. The uplink traffic is limited in bandwidth according to the allocation within the mobile device 310 itself. Here, special control channels 318, 319 are in service between server 301 and mobile devices 310 over the radio channels 312. The channel 318 carries information for available mobile device bandwidth and demand to the server 301 and the channel 319 carries bandwidth allocation information to the mobile device 310. Here, only the interfaces, which are the points to collect the requisite information as to demand and available bandwidth, are different, and the process follows in accordance the processes detailed in FIG. 2 above.

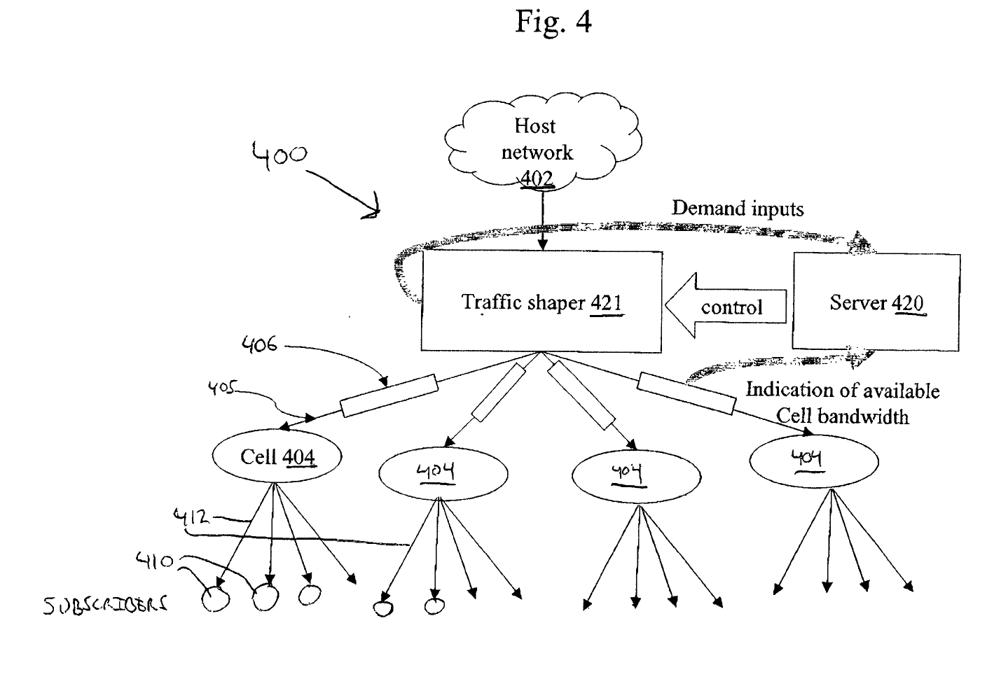

Another embodiment is shown in FIG. 4. In this figure, all system components are similar to those detailed in FIG. 1, with their reference numerals for similar components in the corresponding “400's” rather than the 100's, except where indicated. Here, server 101 has been replaced by a server 420 and a traffic shaper 421. Server 420 is constructed and arranged similarly to server 101, except that the traffic shaping and demand measurements are performed by the traffic shaper 421. Server 420 controls the traffic shaper 420 by allocating sectors and supplements for each service class within each cell, similar to that detailed above. The processes performed by this system 400 are in accordance with those detailed above.

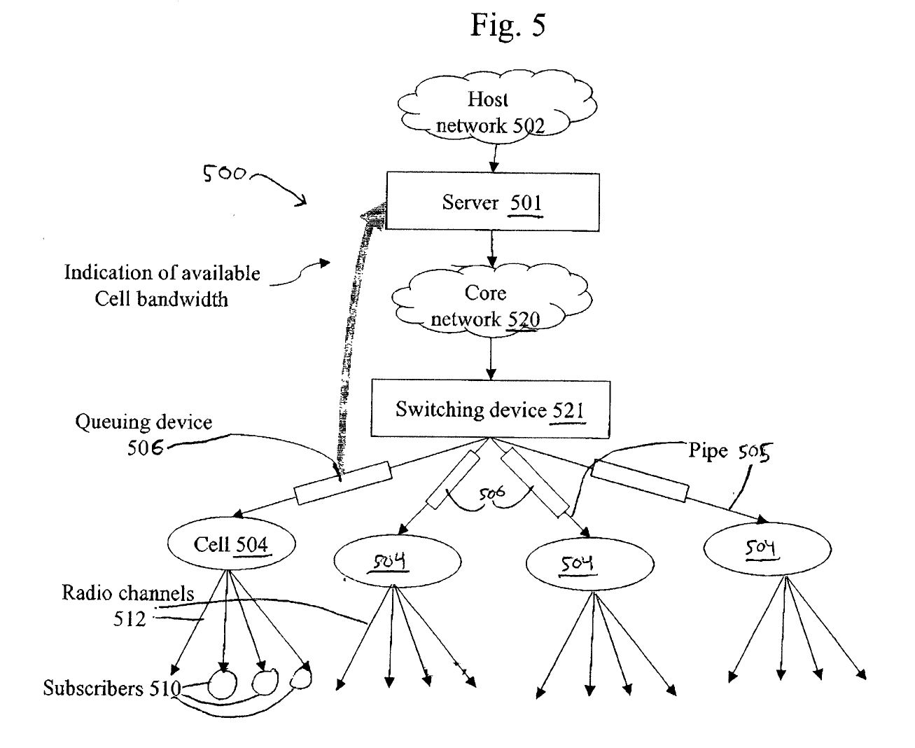

Another embodiment is shown in FIG. 5. In this figure, all system components are similar to those detailed in FIG. 1, with their reference numerals for similar components in the corresponding “500's” rather than the 100's, except where indicated. Here, the server 501 is remote from the pipes 505 and the shared media or cells 504, and connects to the pipes through a core network 520 and switch or switching device 522. The core network 520 and switching device 522 remain transparent to the server 501, and the processes performed by this system 500 are in accordance with those detailed above.

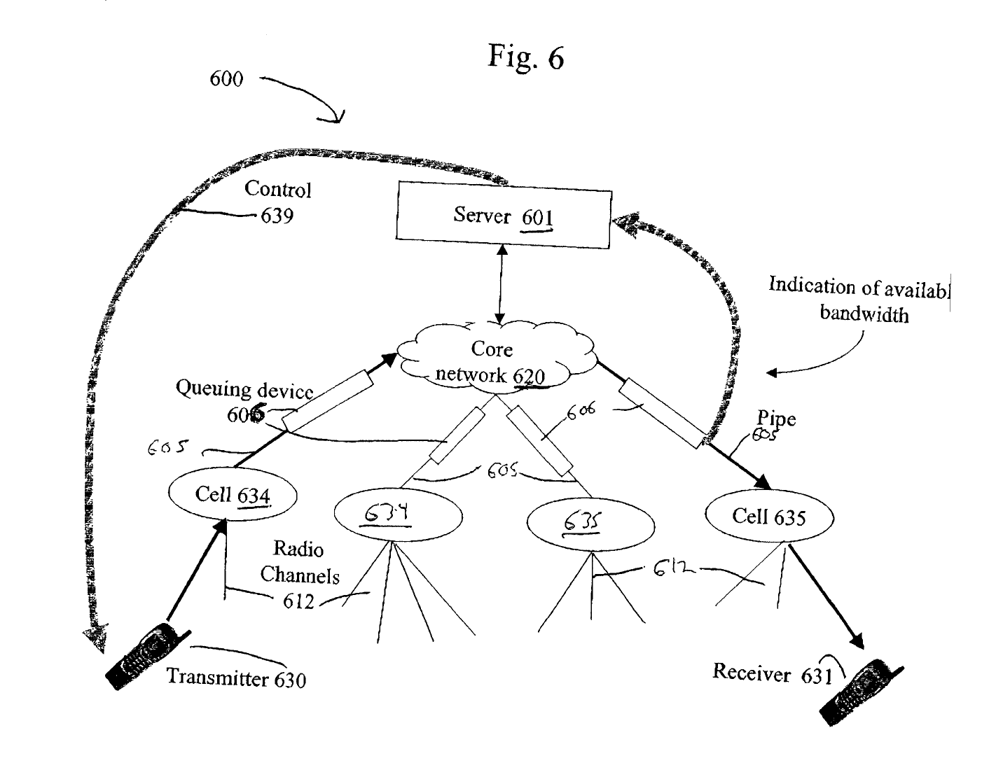

Another embodiment is shown in FIG. 6. In this figure, all system components are similar to those detailed in FIG. 1, with their reference numerals for similar components in the corresponding “600's” rather than the 100's, except where indicated. This system also includes a core network 620, that functions similar to core network 520, as detailed above. Here subscribers are indicate as 630 and 631, to detail a communication over two shared media or cells 634, 635, between a transmitter 630 and a receiver 631.

Operation of the system 600 requires management of uplink traffic, from transmitter 630 through cell 634, and downlink traffic through cell 635 to receiver 631. Available bandwidth and demand in the uplink direction per mobile device, for example, cellular telephone, of the transmitter 630, is performed in a manner similar to that shown and described for FIG. 3 above. The server 601 controls the resource allocation in a manner similar to the server 301 of FIG. 3, over control channel 639 (similar to control channel 319). Available bandwidth and demand in the downlink direction are measured in a manner similar to that described for the system 100 of FIG. 1, above, and downlink traffic to cell 635 is controlled in a manner similar to that described for the system 100 of FIG. 1. The processes performed by this system 600 are in accordance with those detailed above.

A specific application of system 600 is network of multiple connected wireless LANs. Each wireless LAN is a single shared media and the core network 620 provides (stands for) the connectivity between the wireless LANs. The processes performed by this network of multiple connected wireless LANs are in accordance with those detailed above.

The methods and apparatus disclosed herein have been described with exemplary reference to specific hardware and/or software. The methods have been described as exemplary, whereby specific steps and their order can be omitted and/or changed by persons of ordinary skill in the art to reduce embodiments of the present invention to practice without undue experimentation. The methods and apparatus have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for allocating resources in a cellular network comprising:
monitoring said cellular network, said monitoring comprising:
continuously measuring approximate available bandwidth within at least one shared media in said cellular network; and
continuously measuring the demand for bandwidth within said at least one shared media, for at least two service classes; and
automatically changing bandwidth allocations for each of said at least two service classes in accordance with at least one value from said continuously measured approximate available bandwidth and at least one value from said continuously measured demand for bandwidth.

2. The method of claim 1, wherein said automatically changing bandwidth allocations includes setting said bandwidth allocations.

3. The method of claim 2, wherein said setting bandwidth allocations includes:
creating sectors of guaranteed bandwidth.

4. The method of claim 3, wherein said setting bandwidth allocations includes:
creating supplements of non-guaranteed bandwidth for each of said sectors created.

5. The method of claim 2, wherein said setting bandwidth allocations includes:
creating sectors of guaranteed bandwidth; and
creating supplements of non-guaranteed bandwidth for each of said sectors created.

6. The method of claim 1, wherein said automatically changing bandwidth allocations includes tuning said bandwidth allocations.

7. An apparatus for allocating resources in at least one cellular network comprising:
a storage medium; and
a processor, said processor programmed to:
monitor said cellular network, said monitoring comprising:
continuously measuring approximate available bandwidth within at least one shared media in said cellular network; and
continuously measuring the demand for bandwidth within said at least one shared media, for at least two service classes; and
automatically change bandwidth allocations for each of said at least two service classes in accordance with at least one value from said continuously measured approximate available bandwidth and at least one value from said continuously measured demand for bandwidth.

8. The apparatus of claim 7, wherein said processor is additionally programmed to automatically change bandwidth allocations, including setting said bandwidth allocations.

9. The apparatus of claim 8, wherein said processor is additionally programmed to set said bandwidth allocations including:
creating sectors of guaranteed bandwidth.

10. The apparatus of claim 9, wherein said processor is additionally programmed to set said bandwidth allocations including:
creating supplements of non-guaranteed bandwidth for each of said sectors created.

11. The apparatus of claim 8, wherein said processor is additionally programmed to set said bandwidth allocations including:
creating sectors of guaranteed bandwidth; and
creating supplements of non-guaranteed bandwidth for each of said sectors created.

12. The apparatus of claim 7, wherein processor is additionally programmed to automatically change bandwidth allocations, including tuning said bandwidth allocations.

13. A programmable storage device readable by a machine, tangibly embodying a program of instructions executable by a machine to perform method steps for providing resource allocations in a cellular network, said method steps selectively executed during the time when said program of instructions is executed on said machine, comprising:
monitoring said cellular network, said monitoring comprising:
continuously measuring approximate available bandwidth within at least one shared media in said cellular network; and
continuously measuring the demand for bandwidth within said at least one shared media, for at least two service classes; and
automatically changing bandwidth allocations for each of said at least two service classes in accordance with at least one value from said continuously measured approximate available bandwidth and at least one value from said continuously measured demand for bandwidth.
